(19) United States
(12) Patent Application Publication
(10) Pub. No.: US 2025/0304775 A1
(43) Pub. Date: Oct. 2, 2025

(54) Molding Material

(71) Applicant: SEIKO EPSON CORPORATION, Tokyo (JP)

(72) Inventors: Tomohiro FUJITA, Matsumoto (JP); Chieko NAKAJIMA, Suwa (JP); Kiyoaki SAKAGUCHI, Suwa (JP); Daisuke IKEDA, Suwa (JP); Makoto YOSHIDA, Matsumoto (JP)

(21) Appl. No.: 19/092,285

(22) Filed: Mar. 27, 2025

(30) Foreign Application Priority Data
Mar. 28, 2024 (JP) 2024-053216
Mar. 28, 2024 (JP) 2024-053378

(51) Int. Cl. C08L 1/14; C08B 3/16; C08K 3/013; C08L 101/16

(52) U.S. Cl. CPC C08L 1/14; C08B 3/16; C08K 3/013; C08L 101/16; C08K 2201/004; C08K 2201/016; C08L 2201/06

(57) ABSTRACT

A molding material according to an embodiment of the present disclosure includes a resin, and cellulose, the resin includes a combination of an aliphatic polyester and a polyester-based elastomer, or a combination of polylactic acid and an aliphatic polyester other than the polylactic acid, the cellulose includes cellulose having an aspect ratio of less than 6, and an average total length of the cellulose is less than 500 μm.

The present application is based on, and claims priority from JP Application Serial Number 2024-053216, filed Mar. 28, 2024 and JP Application Serial Number 2024-053378, filed Mar. 28, 2024, the disclosures of which are hereby incorporated by reference herein in their entirety.

### BACKGROUND

### 1. Technical Field

The present disclosure relates to a molding material.

### 2. Related Art

In the related art, a molding material including cellulose and a resin is known. For example, JP-A-2005-272783 discloses a natural fiber-reinforced polyester material containing an aliphatic polyester, an elastomer, and pulp.

However, the molding material in the related art cannot be excellent in both mechanical strength and color toning properties when molded into a molded article.

### SUMMARY

According to an aspect of the present disclosure, there is provided a molding material including:
a resin; and
cellulose, in which
the resin includes an aliphatic polyester and a polyester-based elastomer,
the cellulose includes cellulose having an aspect ratio of less than 6, and
an average total length of the cellulose is less than 500 μm.

According to another aspect of the present disclosure, there is provided a molding material including:
a biodegradable resin; and
cellulose, in which
the biodegradable resin includes polylactic acid and an aliphatic polyester other than the polylactic acid,
the cellulose includes cellulose having an aspect ratio of less than 6, and
an average total length of the cellulose is less than 500 μm.

### BRIEF DESCRIPTION OF THE DRAWINGS

FIG. 1 is Table 1 showing the compositions of raw materials and the evaluation results for molding materials of each Example.

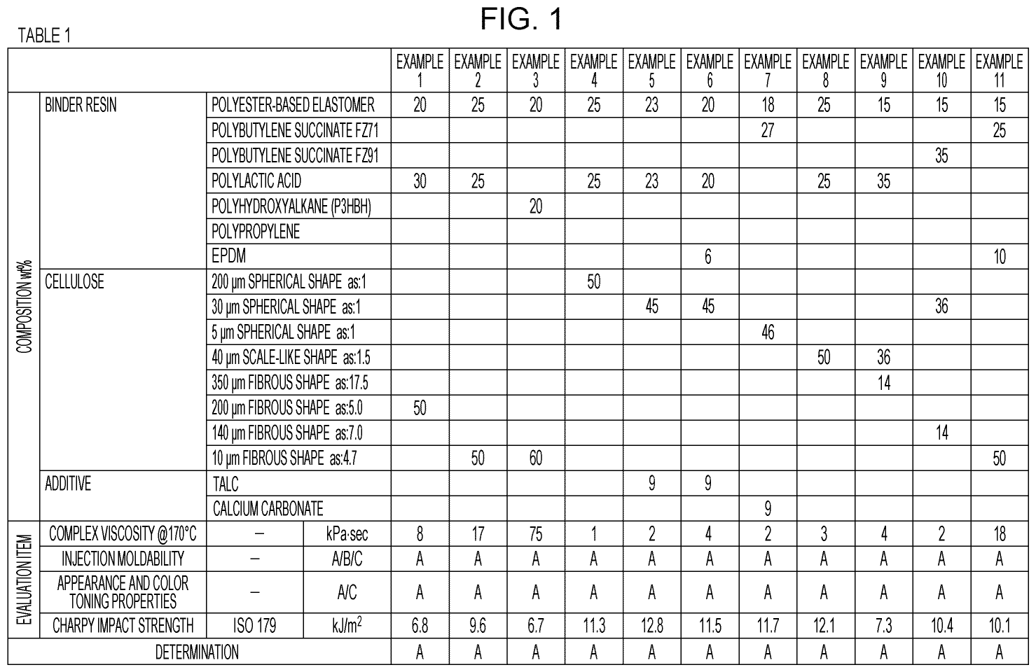

FIG. 2 is Table 2 showing the compositions of raw materials and the evaluation results for molding materials of each Comparative Example.

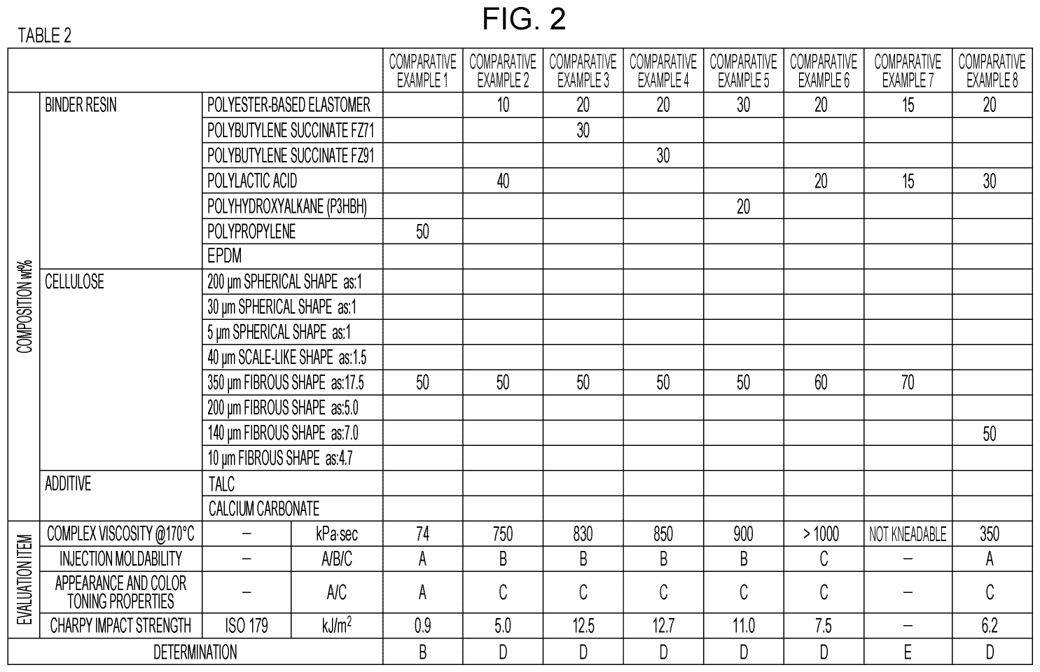

FIG. 3 is Table 3 showing the compositions of raw materials and the evaluation results for molding materials of each Example.

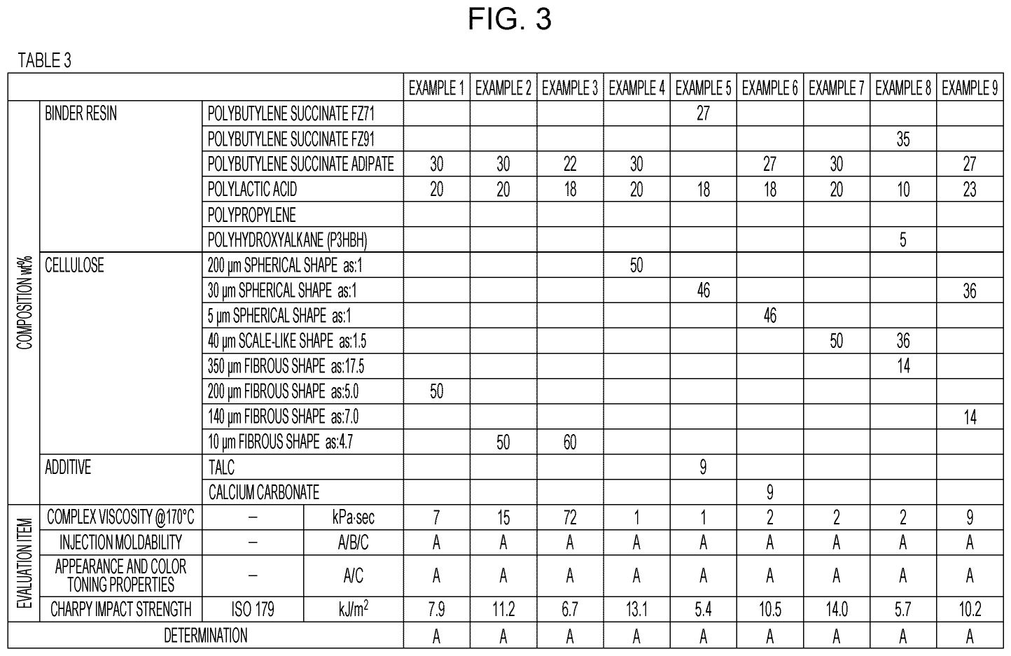

FIG. 4 is Table 4 showing the compositions of raw materials and the evaluation results for molding materials of each Comparative Example.

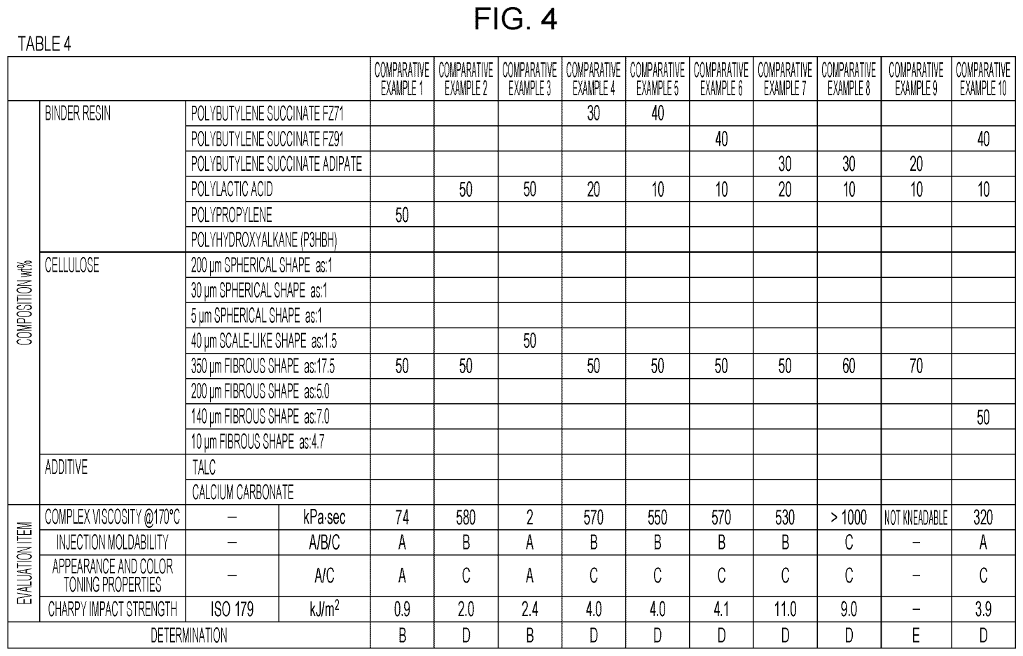

### DESCRIPTION OF EMBODIMENTS

Hereinafter, a first embodiment of the present disclosure will be described. The embodiments described below describe examples of the present disclosure. The present disclosure is not limited to the following embodiments, and includes various modifications implemented within a range not changing the gist of the present disclosure. It should be noted that not all of the configurations described below are essential configurations of the present disclosure.

In the present specification, a numerical range indicated by using “to” means a range including numerical values described before and after “to” as a lower limit value and an upper limit value.

### 1. Molding Material

A molding material according to an embodiment of the present disclosure is a molding material including a resin, and cellulose, the resin includes an aliphatic polyester and a polyester-based elastomer, the cellulose includes cellulose having an aspect ratio of less than 6, and an average total length of the cellulose is less than 500 μm.

In the molding material including the resin and the cellulose, a polyester-based elastomer, which is a flexible resin, may be used in order to improve impact resistance (toughness). The polyester-based elastomer and the cellulose are not excellent in compatibility, and thus interfacial peeling is induced. Therefore, an aliphatic polyester is added in order to promote the interface control (compatibility) between the polyester-based elastomer and the cellulose.

Among synthetic resins, an aliphatic polyester is a resin in which the process of biomass conversion occurs, and the environmental load can be easily reduced by selecting a resin derived from a biomass raw material. On the other hand, since the aliphatic polyester has polarity, the material is easily thickened when kneaded with cellulose, and the cellulose is burned by the heat generated by shearing during kneading. Thus, the molding material is colored and the color toning properties may be impaired.

As a result of further intensive studies by the present inventors, the present inventors have found that when cellulose having an aspect ratio of less than 6 is contained, the thickening of the material during kneading is reduced, and the heat generated by shearing is reduced. Thus, burning of the cellulose is suppressed, and the color toning properties of the molding material can be improved.

As the molding material, a known molding method such as injection molding or pressing can be applied. A molded article produced from the molding material is suitable for various containers, office equipment such as sheets and printers, and housings for home appliances as an alternative to polystyrene.

Hereinafter, each component included in the molding material will be described.

### 1.1 Resin

The molding material according to the present embodiment includes a resin, and the resin includes an aliphatic polyester and a polyester-based elastomer.

The polyester-based elastomer functions as a resin base material and ensures the impact resistance (toughness) of the molded article. However, the compatibility with cellulose is low, and the interfacial peeling between the polyester-based elastomer and the cellulose easily occurs. Therefore, when the aliphatic polyester is used, the aliphatic polyester can function as a compatibilizer between the cellulose and the polyester-based elastomer, and the interfacial peeling can be suppressed.

The content of the resin is preferably 50% by mass or less, more preferably 45% by mass or less, and still more preferably 40% by mass or less with respect to the total amount of the molding material. When the content of the resin is within the above range, the material is easily thickened during kneading and the problem of color toning properties more easily occurs, but in a case of the molding material according to the present embodiment, the color toning properties tend to be improved even in such a case.

The lower limit of the content of the resin is not particularly limited, but is preferably 10% by mass or more, more preferably 20% by mass or more, and still more preferably 30% by mass or more with respect to the total amount of the molding material.

### 1.1.1 Aliphatic Polyester

The resin includes an aliphatic polyester. The aliphatic polyester has thermoplasticity and has a function of melting and binding the cellulose to each other when a molded article is produced from the molding material. In addition, the aliphatic polyester contributes to the physical properties of the molded article together with the cellulose.

The aliphatic polyester is not particularly limited, and may be a saturated aliphatic polyester or an unsaturated aliphatic polyester. In addition, the aliphatic polyester may be linear or cyclic. Among these, the aliphatic polyester is preferably a saturated aliphatic polyester. In addition, the aliphatic polyester is preferably a highly polar polyester.

The content of the aliphatic polyester is preferably 10% by mass or more, more preferably 15% by mass or more, and still more preferably 20% by mass or more with respect to the total amount of the molding material. In addition, the content of the aliphatic polyester is preferably 50% by mass or less, more preferably 45% by mass or less, and still more preferably 40% by mass or less with respect to the total amount of the molding material. When the content of the aliphatic polyester is within the above range, the color toning properties can be improved, and more favorable mechanical strength tends to be obtained.

### 1.1.1.1 Saturated Aliphatic Polyester

The saturated aliphatic polyester is not particularly limited, and is preferably a saturated aliphatic polyester having a linear or branched alkylene group, and more preferably a linear alkyl-based polyester having a linear alkylene group. Such a linear alkyl-based polyester has increased toughness due to the linear alkylene group and tends to mainly improve the impact strength of the molded article.

The saturated aliphatic polyester preferably includes, as raw material monomers, an alkyl dicarboxylic acid having 2 to 8 carbon atoms in the alkylene group and an alkylene diol having 2 to 8 carbon atoms in the alkylene group, more preferably includes an alkyl dicarboxylic acid having 2 to 5 carbon atoms in the alkylene group and an alkylene diol having 3 to 5 carbon atoms in the alkylene group, and still more preferably includes an alkyl dicarboxylic acid having 2 or 3 carbon atoms in the alkylene group and an alkylene diol having 3 or 4 carbon atoms in the alkylene group. When the saturated aliphatic polyester includes the above raw material monomers, more favorable mechanical strength tends to be obtained.

The saturated aliphatic polyester is preferably formed by copolymerizing the above-mentioned two raw material monomers. The copolymerization can be performed by a known synthesis method.

Examples of the alkyl dicarboxylic acids include linear saturated aliphatic dicarboxylic acids such as succinic acid, glutaric acid, adipic acid, pimelic acid, suberic acid, azelaic acid, and sebacic acid. It is preferable to use one or more of these for the synthesis of the saturated aliphatic polyester.

Examples of the above-mentioned alkylene diols include divalent alcohols such as 1,2-ethanediol, 1,3-propanediol, 1,4-butanediol, 1,5-pentanediol, 1,6-hexanediol, 1,7-heptanediol, and 1,8-octanediol. It is preferable to use one or more of these for the synthesis of the saturated aliphatic polyester. The above-mentioned two raw material monomers are relatively easily available and can be applied to industrial or commercial applications.

As the saturated aliphatic polyester, it is preferable to contain at least one or more of polybutylene succinate, polybutylene succinate adipate, and polyethylene diadipate. Since these saturated aliphatic polyesters have biodegradability, the environmental load of the molded article can be reduced, and more favorable mechanical strength tends to be obtained.

The weight average molecular weight of the saturated aliphatic polyesters is not particularly limited, and may be 5000 or more, 10000 or more, or 50000 or more. The weight average molecular weight of the saturated aliphatic polyester may be 200000 or less, 150000 or less, or 100000 or less.

### 1.1.1.2 Highly Polar Polyester

The highly polar polyester is an aliphatic polyester having a molecular structure with a relatively high polarity, and the number of oxygen atoms is preferably 1 or more with respect to 2 carbon atoms in the repeating structure derived from the raw material monomer. Specifically, the highly polar polyester preferably includes, as raw material monomers, lactic acid, hydroxybutyric acid, oxysuccinic acid, citric acid, malonic acid, succinic acid, serine, threonine, acrylic acid, methyl acrylate, vinyl acetate, and the like.

Specifically, the highly polar polyester preferably includes one or more of polylactic acid, polyhydroxybutyric acid, polyacrylic acid, polymethyl acrylate, polyvinyl acetate, and the like. In addition, the highly polar polyester may be a copolymer having a structure derived from lactic acid or acetic acid in the molecular structure, such as polyethylene succinate. Among these, the highly polar polyester preferably includes one or more of polylactic acid and polyhydroxybutyric acid. Since such a compound has biodegradability, the environmental load can be reduced, and more favorable mechanical strength tends to be obtained.

### 1.1.2 Polyester-Based Elastomer

The resin includes a polyester-based elastomer. The polyester-based elastomer functions as a resin base material and ensures the impact resistance (toughness) of the molded article. However, the compatibility with cellulose is low, and the interfacial peeling between the polyester-based elastomer and the cellulose easily occurs. Therefore, when the above-mentioned aliphatic polyester is used, the aliphatic polyester can function as a compatibilizer between the cellulose and the polyester-based elastomer, and the interfacial peeling can be suppressed.

The polyester-based elastomer has thermoplasticity and has a function of melting and binding the cellulose to each other when a molded article is produced from the molding material. In addition, the polyester-based elastomer contributes to the physical properties of the molded article together with the cellulose. In particular, the toughness of the molded article is increased and the impact strength is improved by the polyester-based elastomer. Further, the polyester-based elastomer has a possibility of being produced and used as a bioplastic in the future, and is a material that is expected to promote the reduction of environmental load.

The polyester-based elastomer preferably includes, as raw material monomers, an alkyl dicarboxylic acid having 2 to 8 carbon atoms in the alkylene group or a phthalic acid and an alkylene diol having 2 to 8 carbon atoms in the alkylene group. When the polyester-based elastomer includes the above raw material monomers, more favorable mechanical strength tends to be obtained.

The polyester-based elastomer is preferably formed by copolymerizing the above-mentioned two raw material monomers. The copolymerization can be performed by a known synthesis method.

Examples of the alkyl dicarboxylic acids include linear saturated aliphatic dicarboxylic acids such as succinic acid, glutaric acid, adipic acid, pimelic acid, suberic acid, azelaic acid, and sebacic acid. These alkyl dicarboxylic acids may have a substituent in the molecular structure. It is preferable to use one or more of these for the synthesis of the polyester-based elastomer.

The phthalic acid may have a substituent in the molecular structure.

Examples of the above-mentioned alkylene diols include divalent alcohols such as 1,2-ethanediol, 1,3-propanediol, 1,4-butanediol, 1,5-pentanediol, 1,6-hexanediol, 1,7-heptanediol, and 1,8-octanediol. It is preferable to use one or more of these for the synthesis of the polyester-based elastomer. The above-mentioned three raw material monomers are relatively easily available and can be applied to industrial or commercial applications.

The polyester-based elastomer may include other raw material monomers in addition to the raw material monomers described above. Examples of other raw material monomers include styrene, butadiene, acrylic acid, acrylic acid ester, methacrylic acid, methacrylic acid ester, acetonitrile, isobutylene, isoprene, and ethylene, and one or more of these are preferably used. When other raw material monomers are included, more favorable mechanical strength tends to be obtained.

When incorporating other raw material monomers into the polyester-based elastomer, the total mole number of other raw material monomers is preferably 18 or more and less than 50% with respect to the total mole number of the raw material monomers. As a result, more favorable mechanical strength tends to be obtained.

A commercially available product may be used as the polyester-based elastomer. Examples of the commercially available product include ES-A60NX, E-D27N, E-D42N, and ES series (all trade names) from ARONKASEI Co., Ltd. As the polyester-based elastomer, one or more of these can be applied.

Here, in the form of the molding material or the molded article, the presence or absence of the polyester-based elastomer can be determined by the following physical property analysis and component analysis.

First, in the physical property analysis, the presence or absence of a component having a composite elastic modulus of 100 MPa or less is confirmed. When the above component is included, it is determined that the elastomer component is included. Specifically, for example, the cross section of the molding material or the molded article is measured in a contact mode using a scanning probe microscope NX20 manufactured by Park Systems Corporation. As a result, the presence or absence of the component having a composite elastic modulus of 100 MPa can be confirmed. The presence or absence of the elastomer component may be confirmed using a known nanoindenter.

Next, a qualitative analysis using a combination of a thermal decomposition gas chromatography mass spectrometry (GC-MS) method and a Fourier transform infrared spectroscopy (FT-IR) method is performed to determine whether the elastomer component is a polyester-based elastomer. The thermal decomposition GC-MS method is an analysis method for identifying various fragments generated by thermally decomposing a sample. The FT-IR method is an analysis method for identifying the molecular structure of a sample from an infrared absorption spectrum of the sample. As a result, the molecular structure of the sample can be specified.

For the thermal decomposition GC-MS method, for example, a multi-shot pyrolyzer EGA/PY-3030D of Frontier Laboratories Ltd. and a GC/MS 5975 of Agilent Technology, which is equipped with the apparatus, are used. For example, in the FT-IR method, Nicolet (registered trademark) 380 Continuum (registered trademark) manufactured by Thermo Fisher Scientific Inc. is used.

### 1.1.3 Other Resins

The resin included in the molding material according to the present embodiment may include resins other than the above. Examples of the resins include olefin-based resins such as polyethylene and polypropylene, urethane-based resins, acrylic resins, and the like.

### 1.2 Cellulose

The molding material according to the present embodiment includes cellulose, the cellulose includes cellulose having an aspect ratio of less than 6, and the average total length of the cellulose is less than 500 μm.

The cellulose functions as a filler in the molded article, and contributes to an increase in the bulk of the molding material and an improvement in physical properties such as the strength of the molded article.

Cellulose is a natural material derived from plants and is relatively abundant. Therefore, by using cellulose, the reduction of environmental load is promoted as compared with a case of using a filler obtained by synthesis. Cellulose is advantageous in terms of procurement of raw materials and cost. In addition, cellulose has a high theoretical strength and also contributes to the improvement of the strength of the molded article. As the cellulose, in addition to using virgin pulp, waste paper, old cloth, and the like may be reused. In addition, a commercially available product may be used.

The cellulose may contain a component other than cellulose in the molecular structure thereof. Examples of the component other than cellulose include hemicellulose, lignin, and the like. In addition, the cellulose may be subjected to a treatment such as bleaching.

The cellulose contained in the molding material according to the present embodiment has a cellulose average total length of less than 500 μm. When the average total length of the cellulose is less than 500 μm, the coloration of the cellulose itself is reduced, and thus the color toning properties of the molding material can be improved.

The average total length of the cellulose refers to the average of the longest lengths of the length, width, and height of the shape of the cellulose. That is, the average total length of the cellulose refers to the average of the maximum side lengths or the average of the maximum diameters of the cellulose. Specifically, when the shape of the cellulose is, for example, a fibrous shape, the average total length is an average fiber length, when the shape is, for example, a scale-like shape, the average total length is an average vertical side length (maximum side length), and when the shape is, for example, a spherical shape, the average total length is an average maximum diameter. The fiber length refers to a distance along the curvature when the fiber is curved.

The “average” may be a number average, a length-weighted average, or a length-length-weighted average.

The average total length of the cellulose can be obtained by the following method. For example, the average total length may be obtained using a scanning electron microscope “S-4700” manufactured by Hitachi High-Tech Corporation by performing scale calibration in the SEM with a calibration standard sample “S2009T” manufactured by EM Japan Co., Ltd., and measuring the length of 100 cellulose fibers collected optionally and randomly. In addition, using a particle shape image analysis apparatus “PITA-04” manufactured by Seishin Enterprise Co., Ltd., the average total length can be obtained by setting 50 mL of a dispersion liquid of a sample adjusted to 0.05 wt % to 0.1 wt % in the apparatus and performing measurement. The average fiber length of cellulose when the cellulose has a fibrous shape is obtained by a method in accordance with ISO 16065-2:2007.

The average total length of the cellulose is not particularly limited as long as the average total length is less than 500 μm, and is preferably 400 μm or less, more preferably 300 μm or less, still more preferably 200 μm or less, particularly preferably 150 μm or less, and more particularly preferably 100 μm or less. When the average total length is within the above range, the color toning properties of the molding material may be further improved.

The total length distribution width of the cellulose ((D90−D10)/D50) is not particularly limited, and is preferably 5.0 or less, more preferably 4.0 or less, even more preferably 3.0 or less, particularly preferably 2.0 or less, and more particularly preferably 1.5 or less. The D10, D50, and D90 respectively indicate the total lengths corresponding to 10%, 50%, and 90% of the cumulative volume frequency calculated from the shorter total length of cellulose.

The total length distribution width of the cellulose can be obtained by the following method. For example, using “L&W Fiber Tester Plus” manufactured by ABB, the total length distribution width can be obtained by setting 300 mL of a dispersion liquid of a sample adjusted to 0.1 wt % in the apparatus and performing measurement. In addition, using a laser diffraction particle size distribution measuring apparatus “MT3300EXII” manufactured by MicrotracBEL, the total length distribution width can be obtained by setting 20 mL of a dispersion liquid of a sample adjusted to 0.05 wt % to 0.1 wt % in the apparatus and performing measurement by a laser diffraction/Mie scattering method.

The crystal structure of the cellulose is not particularly limited, and may be type I, type II, type III, type IV, or amorphous. However, fibrous cellulose is preferably type I, spherical cellulose is preferably type II, and scale-like cellulose is preferably amorphous.

The crystallization rate of the cellulose is not particularly limited, and is preferably 50% to 90%, more preferably 55% to 80%, and particularly preferably 60% to 75%. The crystallization rate of the cellulose can be calculated, for example, from each peak area (for example, 20=22.6° in cellulose I type and 20=20.2° in cellulose II type) obtained by using a sealed X-ray tube (Cu, output 40 kV, 40 mA) with an X-ray diffractometer “PANalytical X′PERT” manufactured by Malvern Panalytical Ltd.

The cellulose contained in the molding material according to the present embodiment includes cellulose having an aspect ratio of less than 6. When the cellulose includes cellulose having an aspect ratio of less than 6, the thickening of the material during kneading is reduced, and the heat generated by shearing can be reduced. Thus, burning of the cellulose is suppressed, and the color toning properties of the molding material can be improved.

The aspect ratio of the cellulose refers to the ratio of two long sides of the length, width, and height of the shape of cellulose. Specifically, when the shape of the cellulose is, for example, a fibrous shape, the aspect ratio is a value obtained by dividing the fiber length by the fiber width, when the shape of the cellulose is, for example, a scale-like shape, the aspect ratio is a value obtained by dividing the vertical side length (maximum side length) by the horizontal side length, and when the shape of the cellulose is, for example, a spherical shape, the aspect ratio is a value obtained by dividing the longest diameter among three diameters by the next longest diameter. As described above, the thickness direction is not taken into consideration in the calculation of the aspect ratio.

The aspect ratio of the cellulose can be obtained by the same measurement method as the measurement method of the average total length of the cellulose.

In the cellulose having an aspect ratio of less than 6, the aspect ratio is not particularly limited as long as the aspect ratio is less than 6. The aspect ratio is preferably 5 or less, more preferably 4 or less, still more preferably 3 or less, particularly preferably 2 or less, and more particularly preferably 1.5 or less.

The shape of the cellulose having an aspect ratio of less than 6 is not particularly limited, and is preferably at least one selected from a fibrous shape, a scale-like shape, and a spherical shape. In the molding material according to the present embodiment, as long as the cellulose includes cellulose having an aspect ratio of less than 6, the color toning properties of the molding material can be improved regardless of the shape.

The content of the cellulose having an aspect ratio of less than 6 is preferably 70% by mass or more, more preferably 80% by mass or more, still more preferably 90% by mass or more, particularly preferably 95% by mass or more, and more particularly preferably 100% by mass with respect to the total amount of the cellulose contained in the molding material. When the content of the cellulose having an aspect ratio of less than 6 is within the above range, the color toning properties of the molding material tend to be further improved.

The content of the cellulose is preferably 30% by mass or more, more preferably 40% by mass or more, and still more preferably 50% by mass or more with respect to the total amount of the molding material. In addition, the content of the cellulose is preferably 90% by mass or less, more preferably 80% by mass or less, still more preferably 70% by mass or less, and particularly preferably 65% by mass or less, with respect to the total amount of the molding material. When the content of the cellulose is within the above range, the material is easily thickened during kneading and the problem of color toning properties more easily occurs, but in a case of the molding material according to the present embodiment, the color toning properties tend to be improved even in such a case.

The amount of the cellulose in the molding material can be measured by quantifying the total amount of a composite filler by dissolving the molding material in a chloroform solvent and measuring the weight of the residue, and quantifying the amount of the cellulose in the composite filler by fluorescent X-ray analysis (for example, “JSX-1000S” manufactured by JEOL Ltd.).

### 1.3 Inorganic Filler

The molding material according to the present embodiment may further include an inorganic filler. When an inorganic filler is included, the material may be easily thickened during kneading, and the problem of color toning properties more easily occurs, but in the case of the molding material according to the present embodiment, the color toning properties tend to be improved even in such a case.

Examples of the inorganic filler include a metal such as aluminum; a silicate such as clay, talc, mica, kaolin, zeolite, calcium silicate, montmorillonite, and bentonite; an oxide such as silica, diatomaceous earth, aluminum oxide, zirconium oxide, barium ferrite, barium oxide, and pumice; a hydroxide such as aluminum hydroxide, magnesium hydroxide, and basic magnesium carbonate; a carbonate such as calcium carbonate, magnesium carbonate, dolomite, and dawsonite; a particle made of an inorganic material such as a sulfate or sulfite such as calcium sulfate, barium sulfate, and calcium sulfite; and a fiber made of an inorganic material such as glass fiber.

The volume average particle diameter of the inorganic filler is not particularly limited, and is preferably 0.1 μm or more and 100 μm or less, more preferably 0.1 μm or more and 50 μm or less, and still more preferably 0.1 μm or more and 10 μm or less.

The content when containing the inorganic filler is preferably 1% by mass to 20% by mass, more preferably 3% by mass to 17% by mass, still more preferably 5% by mass to 15% by mass, and particularly preferably 7% by mass to 12% by mass, with respect to the total amount of the molding material.

### 1.4 Other Components

The molding material according to the present embodiment may include, for example, components such as a colorant, a flame retardant, an insect repellent, a fungicide, an antioxidant, an ultraviolet absorber, an aggregation inhibitor, and a mold release agent.

### 1.5 Physical Properties

The molding material according to the present embodiment preferably has a complex viscosity of 600 to 80000 Pa·sec at 170° C., more preferably 600 to 40000 Pa·sec, still more preferably 600 to 20000 Pa·sec, still even more preferably 600 to 10000 Pa·sec, and particularly preferably 1000 to 5000 Pa·sec. When the complex viscosity at 170° C. is within the above range, the color toning properties of the molding material tend to be further improved.

The method for measuring the complex viscosity is not particularly limited, and for example, the complex viscosity can be obtained by measuring the viscoelasticity under the conditions of a measurement temperature of 170° C., a frequency of 1 Hz, and a strain of 8% using “ARES-G2” manufactured by TA Instruments in accordance with JIS K 7244-10 (ISO 6721-10).

### 2. Method for Producing Molding Material

A method for producing a molding material will be described. A known method can be applied to the production of the molding material. Specifically, for example, the following method can be applied.

First, the above-mentioned raw materials (each component of the molding material) are kneaded with a single screw kneader or a twin screw kneader and the kneaded product is formed into a strand shape. Next, the material is pelletized to form a pellet-shaped molding material.

In addition, the following method may also be applied as a method for producing the molding material. First, waste paper or pulp material is coarsely crushed by a shredder to obtain cellulose. Then, the cellulose and a resin containing an aliphatic polyester and a polyester-based elastomer are weighed and kneaded. Next, the kneaded raw material is accumulated in the air to obtain a sheet-like deposit. Since the deposit contains a large amount of air and has a low density, the deposit is compressed with a calender device to remove the air and increase the density. Next, heating is performed in a non-contact manner by using a heating furnace, and then heat pressing is performed by using a heat press device.

In the heating furnace and the heat press device, it is preferable to perform heating at a temperature substantially 20° C. higher than the melting temperature of the resin. As a result, a sheet in which each raw material is dispersed with suppressed bias tends to be formed.

Next, the sheet is cut into a desired shape by a shredder to form a pellet-shaped molding material. The desired shape of the molding material is not particularly limited, and is a substantially cubic shape of 2 mm³ to 5 mm³. The molding material is produced by the above method. The method for producing the molding material is not limited to the above.

### 3. Examples

Hereinafter, the present disclosure will be described in more detail with reference to examples, but the present disclosure is not limited to these examples. Hereinafter, “%” is based on mass unless otherwise specified.

### 3.1 Production of Molding Material and Evaluation Sample

The molding materials according to each Example and each Comparative Example were produced in accordance with the compositions shown in Tables 1 and 2.

Specifically, each component was charged into a twin screw kneader “KZW15TW-45 MG” manufactured by Technobell Co., Ltd. and kneaded to have the compositions shown in Tables 1 and 2. For the kneading conditions, the maximum heating temperature was set to 180° C. and the extrusion discharge rate was set to 1 kg/hr. Next, the material was stranded and then formed into a pellet-shaped molding material with a pelletizer.

The molding materials according to each Example and each Comparative Example were used to carry out molding by injection molding or pressing. Specifically, in both the injection molding and the pressing, the heating temperature of the molding material was set to 200° C. As an injection molding apparatus, “THX40-5V” manufactured by Nissei Plastic Industrial Co., Ltd., was used and as a pressing apparatus, “PHKS-40ABS” manufactured by Towa Seiki Co., Ltd. was used.

Explanations regarding Tables 1 and 2 will be supplemented.
Polyester-based elastomer (trade name “ES-A60NX”, ARONKASEI Co., Ltd.)
Polybutylene succinate FZ71 (trade name “BioPBS FZ71”, manufactured by Mitsubishi Chemical Corporation, weight average molecular weight MW: 70000)·
Polybutylene succinate FZ91 (trade name “BioPBS FZ91”, manufactured by Mitsubishi Chemical Corporation, weight average molecular weight MW: 92000)·
Polyhydroxyalkane (P3HBH, poly [(R)-3-hydroxybutyrate-co-(R)-3-hydroxyhexanoate])·
EPDM (ethylene propylene diene rubber, trade name “NORDEL (registered trademark) 3720P”, Dow Toray Co., Ltd.)
200 μm spherical shape (Viscopearl “D-2010” manufactured by Rengo Co., Ltd., aspect ratio: 1.0, distribution width: 1.2, crystallization rate: 65% to 70%, type II crystal structure)·
30 μm spherical shape (Viscopearl “D-30” manufactured by Rengo Co., Ltd., aspect ratio: 1.0, distribution width: 1.8, crystallization rate: 70% to 75%, type II crystal structure)
5 μm spherical shape (Viscopearl “D-5” manufactured by Rengo Co., Ltd., aspect ratio: 1.0, distribution width: 1.1, crystallization rate: 70% to 75%, type II crystal structure)
40 μm scale-like shape (obtained by processing “Guaiba BEKP” manufactured by CMPC with “KGW-G015” manufactured by West, aspect ratio: 1.5, distribution width: 3.8, crystallization rate: 0% to 10%, amorphous)
350 μm fibrous shape (obtained by defibrating “Guaiba BEKP” manufactured by CMPC in a twin screw kneader, aspect ratio: 17.5, distribution width: 1.0, crystallization rate: 58% to 65%, type I crystal structure)
200 μm fibrous shape (“KC Flock W-80”, manufactured by Nippon Paper Industries Co., Ltd., aspect ratio: 5.0, distribution width: 3.5, crystallization rate: 63% to 67%, type I crystal structure)
140 μm fibrous shape (“KC Flock W-100”, manufactured by Nippon Paper Industries Co., Ltd., aspect ratio: 7.0, distribution width: 3.2, crystallization rate: 63% to 67%, type I crystal structure)
40 μm fibrous shape (“KC Flock W-300G”, manufactured by Nippon Paper Industries Co., Ltd., aspect ratio: 6.7, distribution width: 2.5, crystallization rate: 63% to 67%, type I crystal structure)·
10 μm fibrous shape (“NP Fiber W-6”, manufactured by Nippon Paper Industries Co., Ltd., aspect ratio: 4.7, distribution width: 1.5, crystallization rate: 65% to 69%, type I crystal structure)·
Talc (NANOACE, manufactured by Nippon Talc Co., Ltd., volume average particle diameter: 1.5 μm)
Calcium carbonate (manufactured by Takehara Chemical

The total length and the aspect ratio of the cellulose were obtained using a scanning electron microscope “S-4700” manufactured by Hitachi High-Tech Corporation by performing scale calibration in the SEM with a calibration standard sample “S2009T” manufactured by EM Japan Co., Ltd., measuring the length of 100 cellulose fibers collected optionally and randomly, and obtaining the measured length as a number average.

### 3.2 Evaluation Test

### 3.2.1 Complex Viscosity and Injection Moldability

In the molding materials according to each Example and each Comparative Example obtained above, the viscoelasticity was measured under the conditions of a measurement temperature of 170° C., a frequency of 1 Hz, and a strain of 8% using “ARES-G2” manufactured by TA Instruments, in accordance with JIS K 7244-10 (ISO 6721-10), and the complex viscosity was obtained. The injection moldability was evaluated based on the obtained complex viscosity by the following determination criteria.

### Determination Criteria

A: Complex viscosity is less than 100 kPa·sec.
B: Complex viscosity is 100 kPa·sec or more and 1000 kPa·sec or less.
C: Complex viscosity is more than 1000 kPa·sec.

### 3.2.2 Appearance and Color Toning Properties

In the evaluation samples according to each Example and each Comparative Example obtained above, the L* value was measured using a fluorescence spectrophotometer (FD-7, Konica Minolta Inc.) and determined according to the following criteria. When the determination result is A, favorable appearance and color toning properties are obtained.

### Determination Criteria

A: L* of 70 or more
C: L* of less than 70

### 3.2.3 Charpy Impact Strength

In the evaluation samples according to each Example and each Comparative Example obtained above, the test piece was formed into a rectangular plate shape having a long side of 80 mm±2 mm, a short side of 4.0 mm±0.2 mm, and a thickness of 10.0 mm±0.2 mm, and the Charpy impact strength was measured in accordance with ISO 179 (JIS K 7111) using an “impact tester IT” manufactured by Toyo Seiki Seisaku-sho, Ltd. as a testing apparatus, with a hammer weight of 4 J (WR 2.14 N/m), a lifting angle of 150°, a notch remaining width of 8.0 mm±0.2 mm, and a notch angle of 45°.

### 3.2.4 Comprehensive Evaluation

The comprehensive evaluation was performed according to the following criteria from the evaluation results of the injection moldability, appearance and color toning properties, and Charpy impact strength. When the evaluation result is A, favorable appearance and color toning properties are obtained, and favorable mechanical strength is obtained.

### Determination Criteria

A: Injection moldability and appearance and color toning properties are A, and Charpy impact strength is 6 KJ/m² or more.
B: Injection moldability and appearance and color toning properties are A, and Charpy impact strength is less than 6 KJ/m².
C: Injection moldability is B.
D: Appearance and color toning properties are B.
E: Not kneadable.

### 3.3 Evaluation Results

The evaluation results are shown in Tables 1 and 2.

From the results shown in Tables 1 and 2, the molding material according to each Example, which is a molding material including a resin and cellulose, in which the resin includes an aliphatic polyester and a polyester-based elastomer, the cellulose includes cellulose having an aspect ratio of less than 6, and an average total length of the cellulose is less than 500 μm, was excellent in mechanical strength and color toning properties when molded into a molded article.

On the other hand, the molding material according to each Comparative Example that does not satisfy the above-described configuration could not achieve both mechanical strength and color toning properties when molded into a molded article.

The following contents are derived from the above-described embodiments.

According to an aspect, there is provided a molding material including:
a resin; and
cellulose, in which
the resin includes an aliphatic polyester and a polyester-based elastomer,
the cellulose includes cellulose having an aspect ratio of less than 6, and
an average total length of the cellulose is less than 500 μm.

In the molding material according to the aspect,
a shape of the cellulose having the aspect ratio of less than 6 may be at least one selected from a fibrous shape, a scale-like shape, and a spherical shape.

In the molding material according to any of the aspects,
a content of the cellulose having the aspect ratio of less than 6 may be 70% by mass or more with respect to a total amount of the cellulose included in the molding material.

In the molding material according to any of the aspects,
a complex viscosity of the molding material at 170° C. may be 600 to 80000 Pa·sec.

In the molding material according to any of the aspects,
the molding material may further include an inorganic filler.

In the molding material according to any of the aspects,
a content of the resin may be 50% by mass or less with respect to a total amount of the molding material.

Hereinafter, a second embodiment of the present disclosure will be described. The embodiments described below describe examples of the present disclosure. The present disclosure is not limited to the following embodiments, and includes various modifications implemented within a range not changing the gist of the present disclosure. It should be noted that not all of the configurations described below are essential configurations of the present disclosure.

In the present specification, a numerical range indicated by using “to” means a range including numerical values described before and after “to” as a lower limit value and an upper limit value.

### 1. Molding Material

A molding material according to an embodiment of the present disclosure is a molding material including a biodegradable resin, and cellulose, the biodegradable resin includes polylactic acid and an aliphatic polyester other than the polylactic acid, the cellulose includes cellulose having an aspect ratio of less than 6, and an average total length of the cellulose is less than 500 μm.

In recent years, the production of plastics tends to increase, and even most of the plastic waste collected is buried or discarded in the natural environment (ocean or the like), so that environmental pollution is becoming more serious. Therefore, selecting a biodegradable resin as the molding material can contribute to reducing the burden on the environment. In addition, among synthetic resins, a biodegradable resin is a resin in which the process of biomass conversion particularly occurs, and the environmental load can be easily reduced in particular by selecting a resin derived from a biomass raw material. On the other hand, the biodegradable resin has polarity, the material is easily thickened when kneaded with cellulose, and the cellulose is burned by the heat generated by shearing during kneading. Thus, the molding material is colored and the color toning properties may be impaired.

Therefore, the color of a molded article using a biodegradable molding material in the related art is brown, and the color of a molded article using a biodegradable molding material is so-called earth color, that is, a color that is easily blended into the natural environment. Therefore, even when the molded article is discarded in the natural world, the molded article is not noticeable, and the material has biodegradability. Thus, there is a concern that the consumer may be encouraged to inappropriately discard the molded article in the natural world.

Therefore, as a result of the intensive studies by the present inventors, the present inventors have found that when cellulose having an aspect ratio of less than 6 is contained, the thickening of the material during kneading is reduced, and the heat generated by shearing is reduced. Thus, burning of the cellulose is suppressed, and the color toning properties of the molding material can be improved.

Hereinafter, each component included in the molding material will be described.

### 1.1 Biodegradable Resin

The molding material according to the present embodiment includes a biodegradable resin, and the biodegradable resin includes polylactic acid and an aliphatic polyester other than polylactic acid.

The biodegradable resin has thermoplasticity and has a function of melting and binding the cellulose to each other when a molded article is produced from the molding material. In addition, the biodegradable resin imparts biodegradability to a molded article and also contributes to the physical properties of the molded article together with cellulose.

The content of the biodegradable resin is preferably 50% by mass or less, more preferably 45% by mass or less, and still more preferably 40% by mass or less with respect to the total amount of the molding material. When the content of the biodegradable resin is within the above range, the material is easily thickened during kneading and the problem of color toning properties more easily occurs, but in the case of the molding material according to the present embodiment, the color toning properties tend to be improved even in such a case.

The lower limit of the content of the biodegradable resin is not particularly limited, and is preferably 10% by mass or more, more preferably 20% by mass or more, and still more preferably 30% by mass or more with respect to the total amount of the molding material.

### 1.1.1 Polylactic Acid

The biodegradable resin includes polylactic acid. Polylactic acid is a thermoplastic resin obtained by polymerizing lactic acid by a lactide method, direct polymerization, or the like. Examples of the polylactic acid include poly-L-lactic acid obtained by polymerization of L-lactic acid only, poly-D-lactic acid obtained by polymerization of D-lactic acid only, poly-DL-lactic acid obtained by polymerization of L-lactic acid and D-lactic acid, and the like.

The content of the polylactic acid is preferably 5% by mass or more, more preferably 10% by mass or more, and still more preferably 15% by mass or more with respect to the total amount of the molding material. In addition, the content of the polylactic acid is preferably 35% by mass or less, more preferably 30% by mass or less, and still more preferably 25% by mass or less with respect to the total amount of the molding material. When the content of the polylactic acid is within the above range, the color toning properties can be improved, and more favorable mechanical strength tends to be obtained.

### 1.1.2 Aliphatic Polyester

The aliphatic polyester other than the polylactic acid is not particularly limited, and may be a saturated aliphatic polyester or an unsaturated aliphatic polyester. In addition, the aliphatic polyester may be linear or cyclic. Among these, it is preferable that the polyester is an aliphatic polyester or a saturated aliphatic polyester. In addition, the aliphatic polyester is preferably a highly polar polyester.

The content of the aliphatic polyester other than the polylactic acid is preferably 108 by mass or more, more preferably 15% by mass or more, and still more preferably 20% by mass or more with respect to the total amount of the molding material. In addition, the content of the aliphatic polyester other than the polylactic acid is preferably 45% by mass or less, more preferably 40% by mass or less, and still more preferably 35% by mass or less with respect to the total amount of the molding material. When the content of the aliphatic polyester other than the polylactic acid is within the above range, the color toning properties can be improved, and more favorable mechanical strength tends to be obtained.

### 1.1.2.1 Saturated Aliphatic Polyester

The saturated aliphatic polyester is not particularly limited, and is preferably a saturated aliphatic polyester having a linear or branched alkyl group, and more preferably a linear alkyl-based polyester having a linear alkylene group. Such a linear alkyl-based polyester has increased toughness due to the linear alkylene group and tends to mainly improve the impact strength of the molded article.

The saturated aliphatic polyester preferably includes, as raw material monomers, an alkyl dicarboxylic acid having 2 to 8 carbon atoms in the alkylene group and an alkylene diol having 2 to 8 carbon atoms in the alkylene group, more preferably includes an alkyl dicarboxylic acid having 2 to 5 carbon atoms in the alkylene group and an alkylene diol having 3 to 5 carbon atoms in the alkylene group, and still more preferably includes an alkyl dicarboxylic acid having 2 or 3 carbon atoms in the alkylene group and an alkylene diol having 3 or 4 carbon atoms in the alkylene group. When the saturated aliphatic polyester includes the above raw material monomers, more favorable mechanical strength tends to be obtained.

The saturated aliphatic polyester is preferably formed by copolymerizing the above-mentioned two raw material monomers. The copolymerization can be performed by a known synthesis method.

Examples of the alkyl dicarboxylic acids include linear saturated aliphatic dicarboxylic acids such as succinic acid, glutaric acid, adipic acid, pimelic acid, suberic acid, azelaic acid, and sebacic acid. It is preferable to use one or more of these for the synthesis of the saturated aliphatic polyester.

Examples of the above-mentioned alkylene diols include divalent alcohols such as 1,2-ethanediol, 1,3-propanediol, 1,4-butanediol, 1,5-pentanediol, 1,6-hexanediol, 1,7-heptanediol, and 1,8-octanediol. It is preferable to use one or more of these for the synthesis of the saturated aliphatic polyester. The above-mentioned two raw material monomers are relatively easily available and can be applied to industrial or commercial applications.

As the saturated aliphatic polyester, it is preferable to contain at least one or more of polybutylene succinate, polybutylene succinate adipate, and polyethylene diadipate. Since these saturated aliphatic polyesters have biodegradability, the environmental load of the molded article can be reduced, and more favorable mechanical strength tends to be obtained.

The weight average molecular weight of the saturated aliphatic polyesters is not particularly limited, and may be 5000 or more, 10000 or more, or 50000 or more. The weight average molecular weight of the saturated aliphatic polyester may be 200000 or less, 150000 or less, or 100000 or less.

### 1.1.2.2 Highly Polar Polyester

The highly polar polyester is an aliphatic polyester having a molecular structure with a relatively high polarity, and the number of oxygen atoms is preferably 1 or more with respect to 2 carbon atoms in the repeating structure derived from the raw material monomer. Specifically, the highly polar polyester preferably includes, as raw material monomers, hydroxybutyric acid, oxysuccinic acid, citric acid, malonic acid, succinic acid, serine, threonine, acrylic acid, methyl acrylate, vinyl acetate, and the like.

Specifically, the highly polar polyester preferably includes one or more of polyhydroxybutyric acid, polyacrylic acid, polymethyl acrylate, polyvinyl acetate, and the like. In addition, the highly polar polyester may be a copolymer having a structure derived from lactic acid or acetic acid in the molecular structure, such as polyethylene succinate. Among these, the highly polar polyester preferably includes polyhydroxybutyric acid. Since such a compound has biodegradability, the environmental load can be reduced, and more favorable mechanical strength tends to be obtained.

### 1.2 Cellulose

The molding material according to the present embodiment include cellulose, the cellulose include cellulose having an aspect ratio of less than 6, and the average total length of the cellulose is less than 500 μm.

The cellulose functions as a filler in the molded article, and contributes to an increase in the bulk of the molding material and an improvement in physical properties such as the strength of the molded article.

Cellulose is a natural material derived from plants and is relatively abundant. Therefore, by using cellulose, the reduction of environmental load is promoted as compared with a case of using a filler obtained by synthesis. Cellulose is advantageous in terms of procurement of raw materials and cost. In addition, cellulose has a high theoretical strength and also contributes to the improvement of the strength of the molded article. As the cellulose, in addition to using virgin pulp, waste paper, old cloth, and the like may be reused. In addition, a commercially available product may be used.

The cellulose may contain a component other than cellulose in the molecular structure thereof. Examples of the component other than cellulose include hemicellulose, lignin, and the like. In addition, the cellulose may be subjected to a treatment such as bleaching.

The cellulose contained in the molding material according to the present embodiment has a cellulose average total length of less than 500 μm. When the average total length of the cellulose is less than 500 μm, the coloration of the cellulose itself is reduced, and thus the color toning properties of the molding material can be improved.

The average total length of the cellulose refers to the average of the longest lengths of the length, width, and height of the shape of the cellulose. That is, the average total length of the cellulose refers to the average of the maximum side lengths or the average of the maximum diameters of the cellulose. Specifically, when the shape of the cellulose is, for example, a fibrous shape, the average total length is an average fiber length, when the shape is, for example, a scale-like shape, the average total length is an average vertical side length (maximum side length), and when the shape is, for example, a spherical shape, the average total length is an average maximum diameter. The fiber length refers to a distance along the curvature when the fiber is curved.

The “average” may be a number average, a length-weighted average, or a length-length-weighted average.

The average total length of the cellulose can be obtained by the following method. For example, the average total length may be obtained using a scanning electron microscope “S-4700” manufactured by Hitachi High-Tech Corporation by performing scale calibration in the SEM with a calibration standard sample “S2009T” manufactured by EM Japan Co., Ltd., and measuring the length of 100 cellulose fibers collected optionally and randomly. In addition, using a particle shape image analysis apparatus “PITA-04” manufactured by Seishin Enterprise Co., Ltd., the average total length can be obtained by setting 50 mL of a dispersion liquid of a sample adjusted to 0.05 wt % to 0.1 wt % in the apparatus and performing measurement. The average fiber length of cellulose when the cellulose has a fibrous shape is obtained by a method in accordance with ISO 16065-2:2007.

The average total length of the cellulose is not particularly limited as long as the average total length is less than 500 μm, and is preferably 400 μm or less, more preferably 300 μm or less, still more preferably 200 μm or less, particularly preferably 150 μm or less, and more particularly preferably 100 μm or less. When the average total length is within the above range, the color toning properties of the molding material may be further improved.

The total length distribution width of the cellulose ((D90−D10)/D50) is not particularly limited, and is preferably 5.0 or less, more preferably 4.0 or less, even more preferably 3.0 or less, particularly preferably 2.0 or less, and more particularly preferably 1.5 or less. The D10, D50, and D90 respectively indicate the total lengths corresponding to 10%, 50%, and 90% of the cumulative volume frequency calculated from the shorter total length of cellulose.

The total length distribution width of the cellulose can be obtained by the following method. For example, using “L&W Fiber Tester Plus” manufactured by ABB, the total length distribution width can be obtained by setting 300 mL of a dispersion liquid of a sample adjusted to 0.1 wto in the apparatus and performing measurement. In addition, using a laser diffraction particle size distribution measuring apparatus “MT3300EXII” manufactured by MicrotracBEL, the total length distribution width can be obtained by setting 20 mL of a dispersion liquid of a sample adjusted to 0.05 wt % to 0.1 wt % in the apparatus and performing measurement by a laser diffraction/Mie scattering method.

The crystal structure of the cellulose is not particularly limited, and may be type I, type II, type III, type IV, or amorphous. However, fibrous cellulose is preferably type I, spherical cellulose is preferably type II, and scale-like cellulose is preferably amorphous.

The crystallization rate of the cellulose is not particularly limited, and is preferably 50% to 90%, more preferably 55% to 80%, and particularly preferably 60% to 75%. The crystallization rate of the cellulose can be calculated, for example, from each peak area (for example, 2θ=22.6° in cellulose I type and 2θ=20.2° in cellulose II type) obtained by using a sealed X-ray tube (Cu, output 40 kV, 40 mA) with an X-ray diffractometer “PANalytical X′PERT” manufactured by Malvern Panalytical Ltd.

The cellulose contained in the molding material according to the present embodiment includes cellulose having an aspect ratio of less than 6. When the cellulose includes cellulose having an aspect ratio of less than 6, the thickening of the material during kneading is reduced, and the heat generated by shearing can be reduced. Thus, burning of the cellulose is suppressed, and the color toning properties of the molding material can be improved.

The aspect ratio of the cellulose refers to the ratio of two long sides of the length, width, and height of the shape of cellulose. Specifically, when the shape of the cellulose is, for example, a fibrous shape, the aspect ratio is a value obtained by dividing the fiber length by the fiber width, when the shape of the cellulose is, for example, a scale-like shape, the aspect ratio is a value obtained by dividing the vertical side length (maximum side length) by the horizontal side length, and when the shape of the cellulose is, for example, a spherical shape, the aspect ratio is a value obtained by dividing the longest diameter among three diameters by the next longest diameter. As described above, the thickness direction is not taken into consideration in the calculation of the aspect ratio.

The aspect ratio of the cellulose can be obtained by the same measurement method as the measurement method of the average total length of the cellulose.

In the cellulose having an aspect ratio of less than 6, the aspect ratio is not particularly limited as long as the aspect ratio is less than 6. The aspect ratio is preferably 5 or less, more preferably 4 or less, still more preferably 3 or less, particularly preferably 2 or less, and more particularly preferably 1.5 or less.

The shape of the cellulose having an aspect ratio of less than 6 is not particularly limited, and is preferably at least one selected from a fibrous shape, a scale-like shape, and a spherical shape. In the molding material according to the present embodiment, as long as the cellulose includes cellulose having an aspect ratio of less than 6, the color toning properties of the molding material can be improved regardless of the shape.

The content of the cellulose having an aspect ratio of less than 6 is preferably 70% by mass or more, more preferably 80% by mass or more, still more preferably 90% by mass or more, particularly preferably 95% by mass or more, and more particularly preferably 100% by mass with respect to the total amount of the cellulose contained in the molding material. When the content of the cellulose having an aspect ratio of less than 6 is within the above range, the color toning properties of the molding material tend to be further improved.

The content of the cellulose is preferably 30% by mass or more, more preferably 40% by mass or more, and still more preferably 50% by mass or more with respect to the total amount of the molding material. In addition, the content of the cellulose is preferably 90% by mass or less, more preferably 80% by mass or less, still more preferably 70% by mass or less, and particularly preferably 65% by mass or less, with respect to the total amount of the molding material. When the content of the cellulose is within the above range, the material is easily thickened during kneading and the problem of color toning properties more easily occurs, but in a case of the molding material according to the present embodiment, the color toning properties tend to be improved even in such a case.

The amount of the cellulose in the molding material can be measured by quantifying the total amount of a composite filler by dissolving the molding material in a chloroform solvent and measuring the weight of the residue, and quantifying the amount of the cellulose in the composite filler by fluorescent X-ray analysis (for example, “JSX-1000S” manufactured by JEOL Ltd.).

### 1.3 Inorganic Filler

The molding material according to the present embodiment may further include an inorganic filler. When an inorganic filler is included, the material may be easily thickened during kneading, and the problem of color toning properties more easily occurs, but in the case of the molding material according to the present embodiment, the color toning properties tend to be improved even in such a case.

Examples of the inorganic filler include a metal such as aluminum; a silicate such as clay, talc, mica, kaolin, zeolite, calcium silicate, montmorillonite, and bentonite; an oxide such as silica, diatomaceous earth, aluminum oxide, zirconium oxide, barium ferrite, barium oxide, and pumice; a hydroxide such as aluminum hydroxide, magnesium hydroxide, and basic magnesium carbonate; a carbonate such as calcium carbonate, magnesium carbonate, dolomite, and dawsonite; a particle made of an inorganic material such as a sulfate or sulfite such as calcium sulfate, barium sulfate, and calcium sulfite; and a fiber made of an inorganic material such as glass fiber.

The volume average particle diameter of the inorganic filler is not particularly limited, and is preferably 0.1 μm or more and 100 μm or less, more preferably 0.1 μm or more and 50 μm or less, and still more preferably 0.1 μm or more and 10 μm or less.

The content when containing the inorganic filler is preferably 18 by mass to 20% by mass, more preferably 3% by mass to 17% by mass, still more preferably 5% by mass to 15% by mass, and particularly preferably 7% by mass to 12% by mass, with respect to the total amount of the molding material.

### 1.4 Other Components

The molding material according to the present embodiment may include, for example, components such as a colorant, a flame retardant, an insect repellent, a fungicide, an antioxidant, an ultraviolet absorber, an aggregation inhibitor, and a mold release agent.

### 1.5 Physical Properties

The molding material according to the present embodiment preferably has a complex viscosity of 600 to 80000 Pa·sec at 170° C., more preferably 600 to 40000 Pa·sec, still more preferably 600 to 20000 Pa·sec, still even more preferably 600 to 10000 Pa·sec, and particularly preferably 1000 to 5000 Pa·sec. When the complex viscosity at 170° C. is within the above range, the color toning properties of the molding material tend to be further improved.

The method for measuring the complex viscosity is not particularly limited, and for example, the complex viscosity can be obtained by measuring the viscoelasticity under the conditions of a measurement temperature of 170° C., a frequency of 1 Hz, and a strain of 8% using “ARES-G2” manufactured by TA Instruments in accordance with JIS K 7244-10 (ISO 6721-10).

### 2. Method for Producing Molding Material

A method for producing a molding material will be described. A known method can be applied to the production of the molding material. Specifically, for example, the following method can be applied.

First, the above-mentioned raw materials (each component of the molding material) are kneaded with a single screw kneader or a twin screw kneader and the kneaded product is formed into a strand shape. Next, the material is pelletized to form a pellet-shaped molding material.

In addition, the following method may also be applied as a method for producing the molding material. First, waste paper or pulp material is coarsely crushed by a shredder to obtain cellulose. Then, the cellulose and a biodegradable resin are weighed and kneaded. Next, the kneaded raw material is accumulated in the air to obtain a sheet-like deposit. Since the deposit contains a large amount of air and has a low density, the deposit is compressed with a calender device to remove the air and increase the density. Next, heating is performed in a non-contact manner by using a heating furnace, and then heat pressing is performed by using a heat press device.

In the heating furnace and the heat press device, it is preferable to perform heating at a temperature substantially 20° C. higher than the melting temperature of the biodegradable resin. As a result, a sheet in which each raw material is dispersed with suppressed bias tends to be formed.

Next, the sheet is cut into a desired shape by a shredder to form a pellet-shaped molding material. The desired shape of the molding material is not particularly limited, and is a substantially cubic shape of 2 mm³ to 5 mm³. The molding material is produced by the above method. The method for producing the molding material is not limited to the above.

### 3. Molded Article

A molded article according to an embodiment of the present disclosure is molded using the molding material described above.

The molded article according to the present embodiment can be obtained by using the above-mentioned molding material, and has biodegradability, excellent mechanical strength, and excellent color toning properties.

The molded article according to the present embodiment is preferably a container or tableware. Although there is a higher possibility that a consumer inappropriately discards such a molded article in the natural world, the molded article according to the present embodiment has excellent biodegradability and color toning properties, and thus the possibility of the molded article being inappropriately discarded can be reduced.

The container is not particularly limited, and examples thereof include a food container, an agricultural and gardening container, a blister pack container, a press-through pack container, a fluid container, and the like.

Specific examples of the food container include a tray for fresh food, an instant food container, a fast food container, a lunch box, a beverage container, and the like. Specific examples of the agricultural and gardening container include a seedling pot. Specific examples of the blister pack container include packaging and packaging containers for a wide variety of products for mechanical and industrial applications such as office supplies, toys, and dry batteries, in addition to food. Specific examples of the fluid container include an ink cartridge exterior, a cosmetic container, and the like.

The tableware is not particularly limited, and examples thereof include a plate, a bowl, a pot, chopsticks, a spoon, a fork, a knife, and the like.

### 4. Examples

Hereinafter, the present disclosure will be described in more detail with reference to examples, but the present disclosure is not limited to these examples. Hereinafter, “%” is based on mass unless otherwise specified.

### 4.1 Production of Molding Material and Evaluation Sample

The molding materials according to each Example and each Comparative Example were produced in accordance with the compositions shown in Tables 3 and 4.

Specifically, each component was charged into a twin screw kneader “KZW15TW-45 MG” manufactured by Technobell Co., Ltd. and kneaded to have the compositions shown in Tables 3 and 4. For the kneading conditions, the maximum heating temperature was set to 180° C. and the extrusion discharge rate was set to 1 kg/hr. Next, the material was stranded and then formed into a pellet-shaped molding material with a pelletizer.

The molding materials according to each Example and each Comparative Example were used to carry out molding by injection molding or pressing. Specifically, in both the injection molding and the pressing, the heating temperature of the molding material was set to 200° C. As an injection molding apparatus, “THX40-5V” manufactured by Nissei Plastic Industrial Co., Ltd., was used and as a pressing apparatus, “PHKS-40ABS” manufactured by Towa Seiki Co., Ltd. was used.

Explanations regarding Tables 3 and 4 will be supplemented.
Polybutylene succinate FZ71 (trade name “BioPBS FZ71”, manufactured by Mitsubishi Chemical Corporation, weight average molecular weight MW: 70000)
Polybutylene succinate FZ91 (trade name “BioPBS FZ91”, manufactured by Mitsubishi Chemical Corporation, weight average molecular weight MW: 92000)
Polyhydroxyalkane (P3HBH, poly [(R)-3-hydroxybutyrate-CO-(R)-3-hydroxyhexanoate])
200 μm spherical shape (Viscopearl “D-2010” manufactured by Rengo Co., Ltd., aspect ratio: 1.0, distribution width: 1.2, crystallization rate: 65% to 70%, type II crystal structure)
30 μm spherical shape (Viscopearl “D-30” manufactured by Rengo Co., Ltd., aspect ratio: 1.0, distribution width: 1.8, crystallization rate: 70% to 75%, type II crystal structure).
5 μm spherical shape (Viscopearl “D-5” manufactured by Rengo Co., Ltd., aspect ratio: 1.0, distribution width: 1.1, crystallization rate: 70% to 75%, type II crystal structure)
40 μm scale-like shape (obtained by processing “Guaiba BEKP” manufactured by CMPC with “KGW-G015” manufactured by West, aspect ratio: 1.5, distribution width: 3.8, crystallization rate: 0% to 10%, amorphous)
350 μm fibrous shape (obtained by defibrating “Guaiba BEKP” manufactured by CMPC in a twin screw kneader, aspect ratio: 17.5, distribution width: 1.0, crystallization rate: 58% to 65%, type I crystal structure)
200 μm fibrous shape (“KC Flock W-80”, manufactured by Nippon Paper Industries Co., Ltd., aspect ratio: 5.0, distribution width: 3.5, crystallization rate: 63% to 67%, type I crystal structure)
140 μm fibrous shape (“KC Flock W-100”, manufactured by Nippon Paper Industries Co., Ltd., aspect ratio: 7.0, distribution width: 3.2, crystallization rate: 63% to 67%, type I crystal structure)
10 μm fibrous shape (“NP Fiber W-6”, manufactured by Nippon Paper Industries Co., Ltd., aspect ratio: 4.7, distribution width: 1.5, crystallization rate: 65% to 69%, type I crystal structure)
Talc (NANOACE, manufactured by Nippon Talc Co., Ltd., volume average particle diameter: 1.5 μm)·
Calcium carbonate (manufactured by Takehara Chemical Industrial Co., Ltd., volume average particle diameter: 4.5 μm)

The total length and the aspect ratio of the cellulose were obtained using a scanning electron microscope “S-4700” manufactured by Hitachi High-Tech Corporation by performing scale calibration in the SEM with a calibration standard sample “S2009T” manufactured by EM Japan Co., Ltd., measuring the length of 100 cellulose fibers collected optionally and randomly, and obtaining the measured length as a number average.

### 4.2 Evaluation Test

### 4.2.1 Complex Viscosity and Injection Moldability

In the molding materials according to each Example and each Comparative Example obtained above, the viscoelasticity was measured under the conditions of a measurement temperature of 170° C., a frequency of 1 Hz, and a strain of 8% using “ARES-G2” manufactured by TA Instruments, in accordance with JIS K 7244-10 (ISO 6721-10), and the complex viscosity was obtained. The injection moldability was evaluated based on the obtained complex viscosity by the following determination criteria. When the determination result is A, favorable appearance and color toning properties are obtained.

### Determination Criteria

A: L* of 70 or more.
C: L* of less than 70.

### 4.2.3 Charpy Impact Strength

In the evaluation samples according to each Example and each Comparative Example obtained above, the test piece was formed into a rectangular plate shape having a long side of 80 mm±2 mm, a short side of 4.0 mm±0.2 mm, and a thickness of 10.0 mm±0.2 mm, and the Charpy impact strength was measured in accordance with ISO 179 (JIS K 7111) using an “impact tester IT” manufactured by Toyo Seiki Seisaku-sho, Ltd. as a testing apparatus, with a hammer weight of 4 J (WR 2.14 N/m), a lifting angle of 150°, a notch remaining width of 8.0 mm±0.2 mm, and a notch angle of 45°.

### 4.2.4 Comprehensive Evaluation

The comprehensive evaluation was performed according to the following criteria from the evaluation results of the injection moldability, appearance and color toning properties, and Charpy impact strength. When the evaluation result is A, favorable appearance and color toning properties are obtained, and favorable mechanical strength is obtained.

### Determination Criteria

A: Injection moldability and appearance and color toning properties are A, and Charpy impact strength is 6 KJ/m² or more.
B: Injection moldability and appearance and color toning properties are A and Charpy impact strength is less than 6 KJ/m².
C: Injection moldability is B.
D: Appearance and color toning properties are B.
E: Not kneadable.

### 4.3 Evaluation Results

The evaluation results are shown in Tables 3 and 4.

From the results shown in Tables 3 and 4, the molding material according to each Example, which is a molding material including a biodegradable resin and cellulose, in which the biodegradable resin includes polylactic acid and an aliphatic polyester other than the polylactic acid, the cellulose includes cellulose having an aspect ratio of less than 6, and an average total length of the cellulose is less than 500 μm, had biodegradability, and was excellent in mechanical strength and color toning properties when molded into a molded article.

On the other hand, the molding material according to each Comparative Example that does not satisfy the above-described configuration could not achieve both mechanical strength and color toning properties when molded into a molded article.

The following contents are derived from the above-described embodiments.

According to an aspect, there is provided a molding material including:
a biodegradable resin; and
cellulose, in which
the biodegradable resin includes polylactic acid and an aliphatic polyester other than the polylactic acid,
the cellulose includes cellulose having an aspect ratio of less than 6, and
an average total length of the cellulose is less than 500 μm.

In the molding material according to the aspect,
a shape of the cellulose having the aspect ratio of less than 6 may be at least one selected from a fibrous shape, a scale-like shape, and a spherical shape.

In the molding material according to any of the aspects,
a content of the cellulose having the aspect ratio of less than 6 may be 70% by mass or more with respect to a total amount of the cellulose included in the molding material.

In the molding material according to any of the aspects,
a complex viscosity of the molding material at 170° C. may be 600 to 80000 Pa·sec.

In the molding material according to any of the aspects,
the molding material may further include an inorganic filler.

In the molding material according to any of the aspects,
a content of the biodegradable resin may be 50% by mass or less with respect to a total amount of the molding material.

According to another aspect, there is provided a molded article molded by using the molding material according to any of the aspects.

In the molded article according to the aspect,
the molded article may be a container or tableware.

The present disclosure is not limited to the above-mentioned embodiments, and various modifications can be made. For example, the present disclosure includes a configuration substantially the same as the configuration described in the embodiment, for example, a configuration having the same function, method, and effect, or a configuration having the same object and effect. Further, the present disclosure includes configurations in which non-essential parts of the configuration described in the embodiments are replaced. In addition, the present disclosure includes configurations that achieve the same operational effects or configurations that can achieve the same objects as those of the configurations described in the embodiments. Further, the present disclosure includes configurations in which a known technology is added to the configurations described in the embodiments.

What is claimed is:

1. A molding material comprising:
a resin; and
cellulose, wherein
the resin includes an aliphatic polyester and a polyester-based elastomer,
the cellulose includes cellulose having an aspect ratio of less than 6, and
an average total length of the cellulose is less than 500 μm.

2. The molding material according to claim 1, wherein
a shape of the cellulose having the aspect ratio of less than 6 is at least one selected from a fibrous shape, a scale-like shape, and a spherical shape.

3. The molding material according to claim 1, wherein
a content of the cellulose having the aspect ratio of less than 6 is 70% by mass or more with respect to a total amount of the cellulose included in the molding material.

4. The molding material according to claim 1, wherein
a complex viscosity of the molding material at 170° C. is 600 to 80000 Pa·sec.

5. The molding material according to claim 1, further comprising an inorganic filler.

6. The molding material according to claim 1, wherein
a content of the resin is 50% by mass or less with respect to a total amount of the molding material.

7. A molding material comprising:
a biodegradable resin; and
cellulose, wherein
the biodegradable resin includes polylactic acid and an aliphatic polyester other than the polylactic acid,
the cellulose includes cellulose having an aspect ratio of less than 6, and
an average total length of the cellulose is less than 500 μm.

8. The molding material according to claim 7, wherein
a shape of the cellulose having the aspect ratio of less than 6 is at least one selected from a fibrous shape, a scale-like shape, and a spherical shape.

9. The molding material according to claim 7, wherein
a content of the cellulose having the aspect ratio of less than 6 is 70% by mass or more with respect to a total amount of the cellulose included in the molding material.

10. The molding material according to claim 7, wherein
a complex viscosity of the molding material at 170° C. is 600 to 80000 Pa·sec.

11. The molding material according to claim 7, further comprising an inorganic filler.

12. The molding material according to claim 7, wherein
a content of the biodegradable resin is 50% by mass or less with respect to a total amount of the molding material.

13. A molded article molded by using the molding material according to claim 7.

14. The molded article according to claim 13, wherein
the molded article is a container or tableware.
